(19) United States
(12) Patent Application Publication
(10) Pub. No.: US 2015/0081889 A1
(43) Pub. Date: Mar. 19, 2015

(54) INFORMATION PROCESSING APPARATUS, DEVICE MANAGEMENT SYSTEM AND DEVICE MANAGEMENT METHOD

(71) Applicant: Weibo WANG, Kanagawa (JP)

(72) Inventor: Weibo WANG, Kanagawa (JP)

(21) Appl. No.: 14/482,712

(22) Filed: Sep. 10, 2014

(30) Foreign Application Priority Data
Sep. 17, 2013 (JP) 2013-191885

(51) Int. Cl. H04L 12/26

(52) U.S. Cl. CPC H04L 43/0811
USPC 709/224

(57) ABSTRACT

An information processing apparatus is configured to communicate with a device through a first communication path and to communicate, through a second communication path, with a device management apparatus configured to manage the device, and to include a detection part, a transmission part, a reception part, and an acquisition part. The detection part detects connection with the device through the first communication path. The transmission part transmits predetermined notification including identification information of the information processing apparatus to the device management apparatus, when the connection with the device is detected. The reception part receives a device information acquisition request from the device management apparatus based on the predetermined notification. The acquisition part acquires device information of the device. The transmission part transmits, to the device management apparatus, response to acquisition of the device information including the identification information of the information processing apparatus and the device information.

### CROSS-REFERENCE TO RELATED APPLICATIONS

The present application claims priority to and incorporates by reference the entire contents of Japanese Patent Application No. 2013-191885 filed in Japan on Sep. 17, 2013.

### BACKGROUND OF THE INVENTION

1. Field of the Invention

The present invention relates to an information processing apparatus, a device management system, and a device management method.

2. Description of the Related Art

A device management apparatus is conventionally known which manages a device connected through a network. For example, Japanese Patent No. 3937478 discloses a technology for using a network expansion board having agents for various protocols to connect the devices to be managed with the network, and exchanging management information between processing modules and the devices to be managed using the protocols.

Some device management apparatuses are configured to manage a device through an information processing apparatus such as a personal computer (PC) connected through a network. The device herein is connected to the information processing apparatus through a communication interface, such as a universal serial bus (USB) cable.

### SUMMARY OF THE INVENTION

It is an object of the present invention to at least partially solve the problems in the conventional technology.

According to an aspect of the present invention, there is provided an information processing apparatus that is configured to communicate with a device through a first communication path and to communicate, through a second communication path, with a device management apparatus configured to manage the device, the information processing apparatus including: a detection part configured to detect connection with the device through the first communication path; a transmission part configured to transmit predetermined notification including identification information of the information processing apparatus to the device management apparatus when the connection with the device is detected; a reception part configured to receive a device information acquisition request from the device management apparatus based on the predetermined notification; and an acquisition part configured to acquire device information of the device based on the device information acquisition request, wherein the transmission part transmits, to the device management apparatus, response to acquisition of the device information including the identification information of the information processing apparatus and the device information of the device. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary configuration of a device management system according to the present embodiment;

FIG. 2 is a block diagram illustrating an exemplary configuration of the device management system according to the present embodiment;

FIG. 3 is a block diagram illustrating an exemplary configuration of a PC according to the present embodiment;

FIG. 4 is a view of exemplary response data according to the present embodiment;

FIG. 5 is a view of exemplary response data according to the present embodiment;

FIG. 6 is a block diagram illustrating an exemplary configuration of a device according to the present embodiment;

FIG. 7 is a block diagram illustrating an exemplary configuration of a device management apparatus according to the present embodiment;

FIG. 8 is a table illustrating an example of device information stored in a storage unit by a controller according to the present embodiment;

FIG. 9 is a table illustrating an example of the device information stored in the storage unit by the controller according to the present embodiment;

FIG. 10 is a flowchart illustrating exemplary processing performed when the PC detects the connection of the device in the device management system according to the present embodiment;

FIG. 11 is a flowchart illustrating exemplary processing performed when the PC detects the disconnection of the device in the device management system according to the present embodiment;

FIG. 12 is a flowchart illustrating exemplary protocol determination of the device management apparatus according to the present embodiment;

FIG. 13 is a flowchart illustrating exemplary determination of a protocol conversion module for the PC according to the present embodiment;

FIG. 14 is a table illustrating exemplary device information stored in a storage unit by a controller according to a modification;

FIG. 15 is a view of exemplary response data according to a modification;

FIG. 16 is a view of exemplary response data according to a modification;

FIG. 17 is a block diagram illustrating an exemplary hardware configuration of the PC and the device management apparatus according to the present embodiment; and

FIG. 18 is a block diagram illustrating an exemplary configuration of a device according to a modification.

### DETAILED DESCRIPTION OF THE PREFERRED EMBODIMENT

An embodiment of an information processing apparatus, a device management system, a program, and a device management method according to the present invention will be described below in detail with reference to the accompanying drawings.

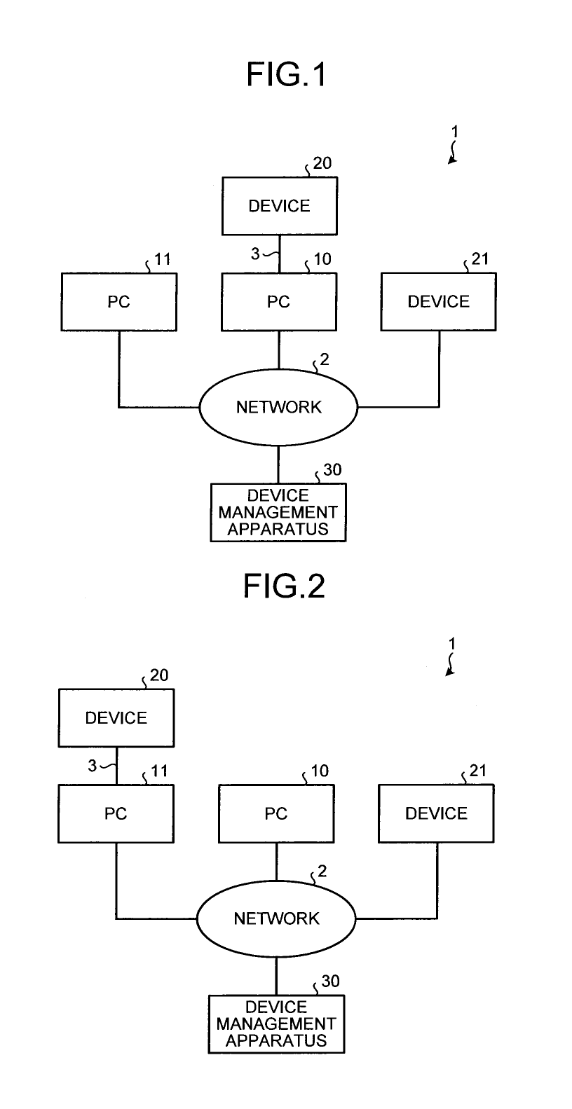

FIGS. 1 and 2 are block diagrams illustrating exemplary configurations of the device management system 1 according to the present embodiment. As illustrated in FIG. 1, the device management system 1 includes personal computers (PC) 10 and 11 (an example of information processing apparatus), devices 20 and 21, and a device management apparatus 30. The PCs 10 and 11, the device 21, and the device management apparatus 30 are connected to one another through a network 2 (an example of second communication path).

The device 20 can be connected to the PC 10 through a communication interface 3 (an example of first communication path) as illustrated in FIG. 1, the device can be connected to the PC 11 through the communication interface 3 as illustrated in FIG. 2, or the device can be connected to the device management apparatus 30 through the network 2, though not illustrated in the figures.

That is, in the device management system 1 according to the present embodiment, at least connection of the device 20 can be locally switched between the PCs through the communication interface 3. Further, the connection can be switched to network connection for the connection to the network 2.

The network 2 includes the Internet, a local area network (LAN), or the like. The communication interface 3 includes a universal serial bus (USB) cable or the like.

The device management apparatus 30 is provided at a service center of a service provider that provides a device management service, and the PCs 10 and 11 and the devices 20 and 21 are provided at service points. The service point is in an area in which a device to be managed is installed. The service point includes, for example, a business office receiving the device management service. It is noted that an installation place of the device management apparatus 30 is not limited to the service center, and the service point or the like may be employed as the installation place.

The device management apparatus 30 is configured to manage the PCs 10 and 11 and the devices 20 and 21, and includes a PC installed with a device management (manager) program which will be described below, or the like. It is obvious that, in FIGS. 1 and 2, the PCs 10 and 11 and the devices 20 and 21 are illustrated as the devices to be managed by the device management apparatus 30, but the device to be managed by the device management apparatus 30 is not to be limited to them.

The PCs 10 and 11 are installed with an agent program which will be described below. As illustrated in FIGS. 1 and 2, while the device 20 is connected through the communication interface 3, when acquisition of device information is requested from the device management apparatus 30, the device information is acquired from the device 20 through the communication interface 3, and the device management apparatus 30 is notified of the device information. Therefore, the device management apparatus 30 can manage the device 20 even if the device 20 is not connected to the network 2.

The device 20 is preferably a device connectable to both of the communication interface 3 and the network 2, and the device 21 is preferably a device connectable to at least the network 2. It is noted that the device 21 may also be connectable to both of the communication interface 3 and the network 2.

Examples of the devices 20 and 21 include an image forming apparatus such as a printer, a copier, a multifunction peripheral, a scanner, and a facsimile machine as well as various electronic devices such as a projector, a camera, an air conditioner, a refrigerator, a fluorescent lamp, an automatic dispenser, and a hand-held terminal. The multifunction peripheral (MFP) has at least two of a copy function, a print function, a scanner function, and a facsimile function. It is noted that in the present embodiment, the devices 20 and 21 will be described as an example of a projector.

It is noted that in the following description, the device connected to the network 2 is sometimes referred to as a network device, and the device connected to the communication interface 3 is sometimes referred to as a local device.

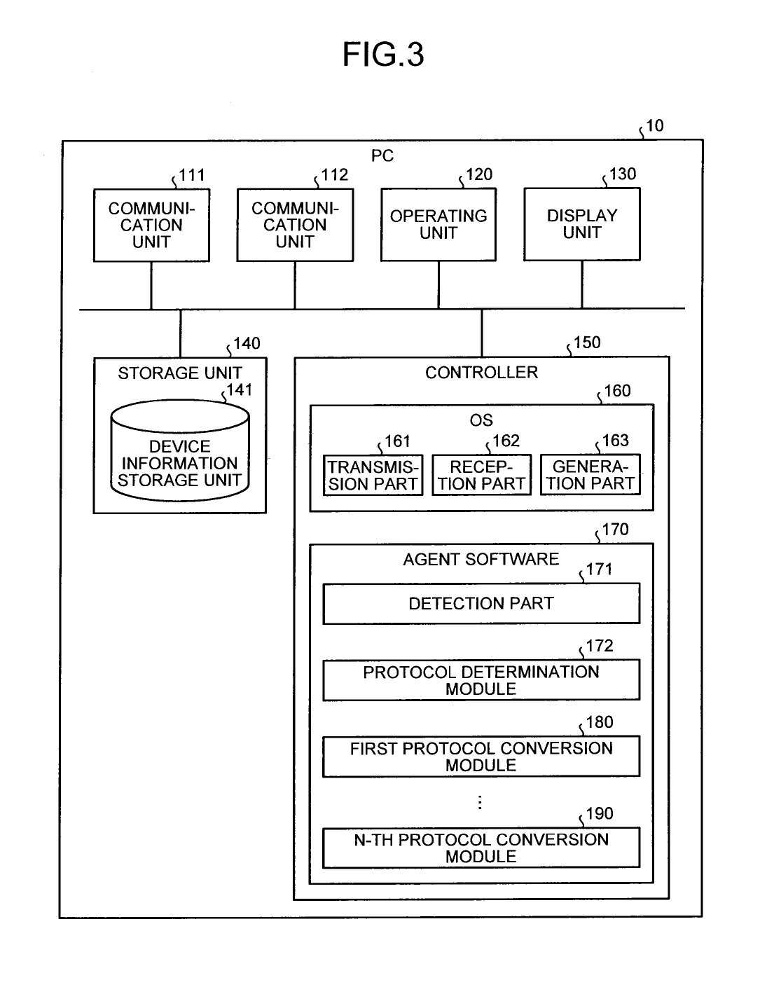

FIG. 3 is a block diagram illustrating an exemplary configuration of the PCs 10 and 11 according to the present embodiment. As illustrated in FIG. 3, the PCs 10 and 11 each include a communication unit 111, a communication unit 112, an operating unit 120, a display unit 130, a storage unit 140, and a controller 150.

The communication unit 111 is configured to communicate with an external apparatus such as the device management apparatus 30 through the network 2, and includes a network interface card (NIC) or the like.

The communication unit 112 communicates with a local device such as the device 20 through the communication interface 3 and includes a USB or the like.

The operating unit 120 is configured to perform various operation inputs, and includes an input device such as a keyboard, a mouse, a touch pad, and a touch panel.

The display unit 130 is configured to display various screens, and includes a display device such as a liquid crystal display and a touch panel display.

The storage unit 140 is configured to store various programs, data, or the like. The various programs include an operating system (OS) program and an agent program which are executed on the PCs 10 and 11. The data is used for various processing performed on the PCs 10 and 11. The storage unit 140 includes at least one of storage devices for magnetic, optical, and electrical storage, for example, a hard disk drive (HDD), a solid state drive (SSD), a memory card, an optical disk, a read only memory (ROM), and a random access memory (RAM).

The storage unit 140 includes a device information storage unit 141 for storing device information of the PCs 10 and 11, and device information of the local device. The device information storage unit 141 stores the device information of the PCs 10 and 11 beforehand, and stores device information of the local device at any time by a controller 150 described below when the local device is connected to the PC.

The device information of the PCs 10 and 11 is preferably information relating to the PCs 10 and 11, for example, serial numbers, IP addresses, MAC addresses, machine names, model names, administrator information, and error information of the PCs 10 and 11. The device information of the local device is preferably information relating to the local device, for example, a serial number, MAC address, machine name, model name, counter information, and error information (call information) of the local device.

The controller 150 is configured to control each unit of the PCs 10 and 11, and includes a control device such as a central processing unit (CPU). The controller 150 includes OS software 160 and agent software 170. The controller 150 runs (executes) the OS program and the agent program stored in the storage unit 140 in order to effect the OS software 160 and the agent software 170.

The OS software 160 is configured to control each unit of the PCs 10 and 11 (in particular, hardware and software of PCs 10 and 11), and includes basic software, for example, Windows (registered trademark) or UNIX (registered trademark). The OS software 160 includes a transmission part 161, a reception part 162, and a generation part 163. It is noted that the transmission part 161, the reception part 162, and the generation part 163 will be described appropriately.

The agent software 170 is configured to acquire device information from the local device. The agent software includes a detection part 171, a protocol determination module 172, and a first protocol conversion module 180 to an n-th (n is a natural number) protocol conversion module 190.

The detection part 171 detects connection with or disconnection from the local device through the communication interface 3.

When connection with the local device is detected by the detection part 171, the transmission part 161 transmits predetermined notification including identification information of the PCs 10 and 11 to the device management apparatus 30. Further, when the disconnection from the local device is detected by the detection part 171, the transmission part 161 transmits the predetermined notification including the identification information of the PCs 10 and 11 to the device management apparatus 30.

For example, the transmission part 161 transmits a TRAP of the simple network management protocol (SNMP) as the predetermined notification to the device management apparatus 30. The identification information of the PCs 10 and 11 preferably includes at least the IP addresses of the PCs 10 and 11.

The reception part 162 receives a device information acquisition request from the device management apparatus 30 based on the predetermined notification. The reception part 162 preferably makes communication using a protocol for communication with the device management apparatus 30. The protocol includes, for example, the SNMP, the hypertext transfer protocol (HTTP), and the simple object access protocol (SOAP).

When the connection with the local device is detected by the detection part 171, the protocol determination module 172 determines a protocol to which the protocol of the device information acquisition request received by the reception part 162 is to be converted. More specifically, the protocol determination module 172 causes the first protocol conversion module 180 to the n-th protocol conversion module 190 (an example of acquisition part) to perform a test communication with the local device. Then, the converted protocol of the device information acquisition request is determined as the protocol conversion module having been used for the test communication in which response has been received from the local device.

It is noted that when the disconnection from the local device is detected by the detection part 171, the protocol determination module 172 cannot communicate with the local device, so that the converted protocol of the device information acquisition request received by the reception part 162 is not determined.

The first protocol conversion module 180 to the n-th protocol conversion module 190 are modules each corresponding to the converted protocol of the device information acquisition request. The protocol conversion module determined by the protocol determination module 172 converts the device information acquisition request to a device information acquisition request for a protocol of itself, communication is performed with the local device, and the device information of the local device is acquired.

The protocol conversion module converts the acquired device information of the local device to a protocol for a response to acquisition of the device information, acquires the IP addresses and MAC addresses of the PCs 10 and 11 from the device information storage unit 141, and generates the response to acquisition of the device information including the IP addresses and MAC addresses of the PCs 10 and 11, and the converted device information of the local device.

It is noted that when the device information of the local device is acquired from periodical processing, the protocol conversion module converts the acquired device information of the local device for the protocol for response to acquisition of the device information to be stored in the device information storage unit 141.

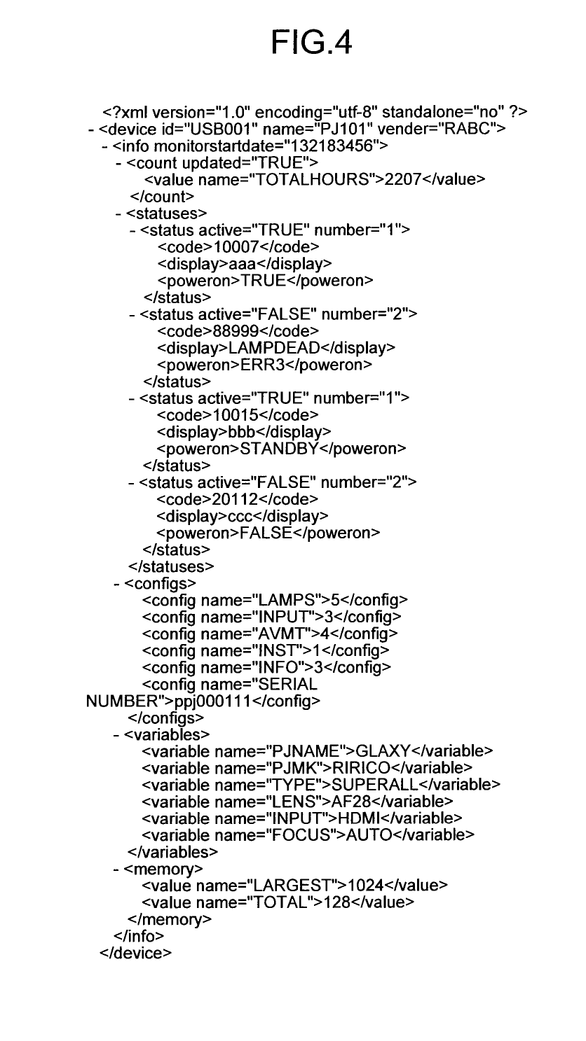

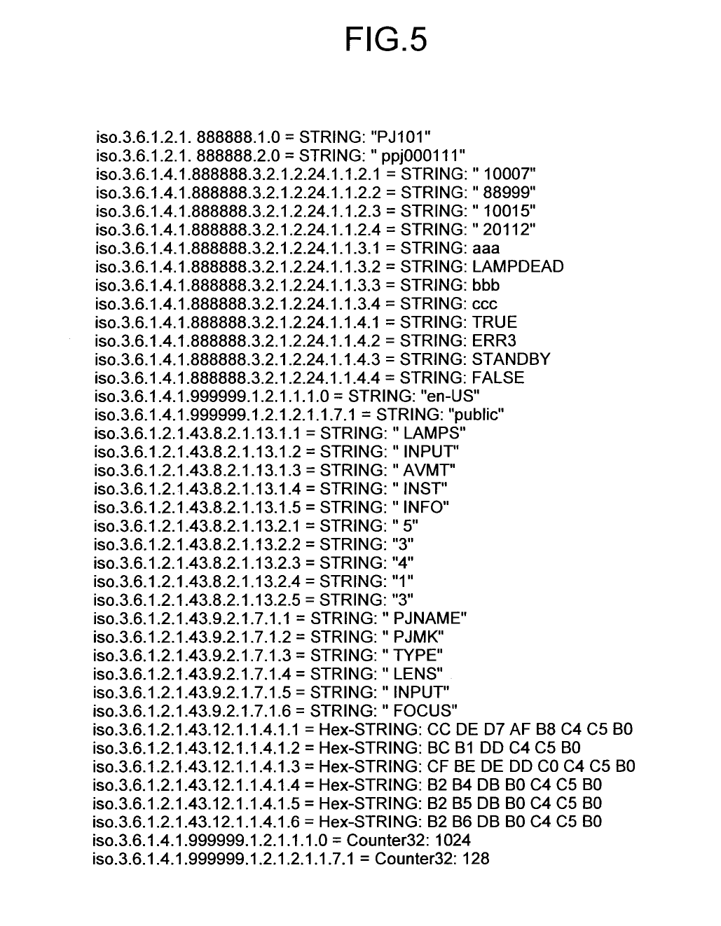

For example, the protocol conversion module formats the acquired device information of the local device in XML data as illustrated in FIG. 4, parses data of a “statuses” tab of the formatted XML data, and converts the parsed data for a protocol (XML) for the response to acquisition of the device information. It is noted that the protocol conversion module may format the acquired device information of the local device in MIB data as illustrated in FIG. 5, and may convert the formatted MIB data for the protocol (SNMP) for the response to acquisition of the device information.

The device information of the local device will be described below to include a serial number and counter information of the local device, or status information such as error information, but it is considered that the device information is not limited to such a configuration.

When the connection with the local device is detected by the detection part 171, the transmission part 161 transmits the response to acquisition of the device information which has been generated by the protocol conversion module to the device management apparatus 30.

On the other hand, when the disconnection from the local device is detected by the detection part 171, the generation part 163 acquires the IP addresses and MAC addresses of the PCs 10 and 11, and the device information of the local device from the device information storage unit 141 to generate the response to acquisition of the device information, and the transmission part 161 transmits the response to acquisition of the device information to the device management apparatus 30.

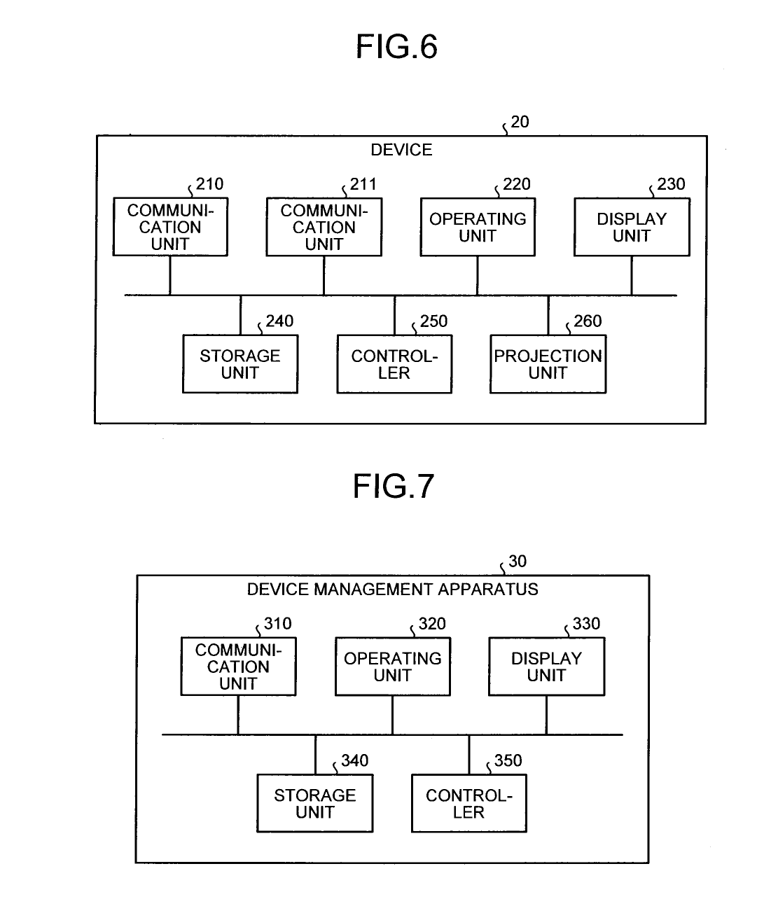

FIG. 6 is a block diagram illustrating an exemplary configuration of the device 20 according to the present embodiment. As illustrated in FIG. 6, the device 20 includes a communication unit 210, a communication unit 211, an operating unit 220, a display unit 230, a storage unit 240, a controller 250, and a projection unit 260.

The communication unit 210 is configured to communicate with the external apparatus such as the device management apparatus 30 through the network 2, and includes an NIC or the like.

The communication unit 211 is configured to communicate with the PCs 10 and 11 through the communication interface 3, and includes a USB or the like.

The operating unit 220 is configured to perform various operation inputs, and includes an input device such as a key switch and a touch panel.

The display unit 230 is configured to display various screens, and includes a display device such as a liquid crystal display or a touch panel display.

The storage unit 240 stores various programs, data, or the like. The various programs are executed in the device 20. The data is used for various processing performed in the device 20, such as device information of the device 20. The device information of the device 20 is preferably information relating to the device 20, for example, a serial number, an IP address, a MAC address, a machine name, a model name, counter information and error information (call information) of the device 20. However, when the device 20 is connected to the network 2, or when the device 20 is a network device, the IP address is stored in the storage unit 240 as the device information.

The controller 250 is configured to control each unit of the device 20, and includes a control device such as a CPU.

When the device 20 is connected to the communication interface 3, the controller 250 transmits the device information to the PCs 10 and 11 through the communication interface 3, upon reception of the device information acquisition request from the PCs 10 and 11 through the communication interface 3. Further, when an error occurs in the device 20, the controller 250 generates the device information to be transmitted to the PCs 10 and 11 through the communication interface 3.

When projection is requested from the PCs 10 and 11 using PJL, the projection unit 260 performs projection.

FIG. 7 is a block diagram illustrating an exemplary configuration of the device management apparatus 30 according to the present embodiment. As illustrated in FIG. 7, the device management apparatus 30 includes a communication unit 310, an operating unit 320, a display unit 330, a storage unit 340, and a controller 350.

The communication unit 310 is configured to communicate with a network device such as the PCs 10, 11 or the devices 20, 21 through the network 2, and includes an NIC or the like.

The operating unit 320 is configured to perform various operation inputs, and includes the input device such as a keyboard, a mouse, a touch pad, and a touch panel.

The display unit 330 is configured to display various screens, and includes a display device such as a liquid crystal display or a touch panel display.

The storage unit 340 stores various programs, data, or the like. The various programs include a device management program executed in the device management apparatus 30. The data is used for various processing performed in the device management apparatus 30. The storage unit 340 includes at least one of storage devices for magnetic, optical, and electrical storage, for example, an HDD, an SSD, a memory card, an optical disk, a ROM, and a RAM. The storage unit 340 stores the device information of the device to be managed by the device management apparatus 30, such as the PCs 10 and 11 or the devices 20 and 21.

The controller 350 is configured to control each unit of the device management apparatus 30, and includes a control device such as a CPU. The controller 350 functions as device management software, and also functions as a manager to the agent software 170 of the PCs 10 and 11.

The controller 350 transmits the device information acquisition request to the PC10 or PC11 based on predetermined notification from the PC10 or PC11. The controller associates the identification information of the PC10 or PC11 with the device information of the local device. The identification information and the device information are included in the response to acquisition of the device information from the PC 10 or PC 11. The associated information is managed on the storage unit 340.

When the device information acquisition request is sent to the PC10 or the PC11, the controller 350 makes test communication with the PC 10 or the PC 11 using various protocols such as SNMP, HTTP, or SOAP. The device information acquisition request is sent to the PC 10 or the PC 11 using the protocol having been used for the test communication through which response has been received from the PC 10 or the PC 11.

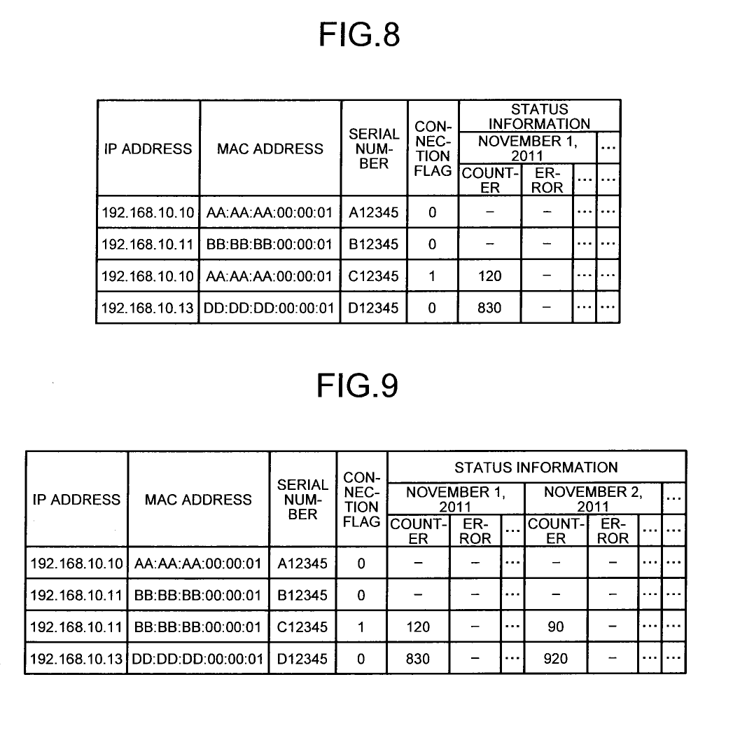

FIGS. 8 and 9 are tables illustrating examples of the device information stored in the storage unit 340 by the controller 350 according to the present embodiment. FIG. 8 illustrates the device information of the devices being connected as illustrated in FIG. 1. FIG. 9 illustrates the device information of the devices being connected as illustrated in FIG. 2 after switching from the connection illustrated in FIG. 1.

As illustrated in FIGS. 8 and 9, the device information stored in the storage unit 340 includes the IP address, the MAC address, the serial number, a connection flag, and the status information. In FIGS. 8 and 9, the device information in the first line (serial number “A12345” or the like) represents information of the PC10, the device-information in the second line (serial number of “B12345” or the like) represents information of the PC11, the device information in the third line (serial number of “C12345” or the like) represents information of the device 20, and the device information in the fourth line (serial number of “D12345” or the like) represents information of the device 21. Further, the connection flag is information representing a connection of the device. A number “0” represents network connection, and a number “1” represents local connection.

In FIG. 1, the device 20 is locally connected with the PC10. Therefore, the controller 350 receives, as the device information of the device 20, for example, the response to acquisition of the device information, including the IP address “192.168.10.10”, MAC address “AA:AA:AA:00:00:01”, serial number “C12345”, and status information such as counter information “120” or error information “-” of the PC10. Therefore, as illustrated in FIG. 8, the controller 350 registers values of the received device information of the device 20 to the storage unit 340, and sets a value of the connection flag to “1”.

After that, when the connection illustrated in FIG. 1 is switched to the connection illustrated in FIG. 2, the device 20 locally connected to the PC11 causes the controller 350 to receive the response to acquisition of the device information, as the device information of the device 20, including for example, the IP address “192.168.10.11”, MAC address “BB:BB:BB:00:00:01”, serial number “C12345”, and status information such as counter information “190” or error information “-” of the PC11. Therefore, as illustrated in FIG. 9, the controller 350 updates the IP address and the MAC address to a value of the PC11, and additionally registers the status information of the device 20 to the storage unit 340.

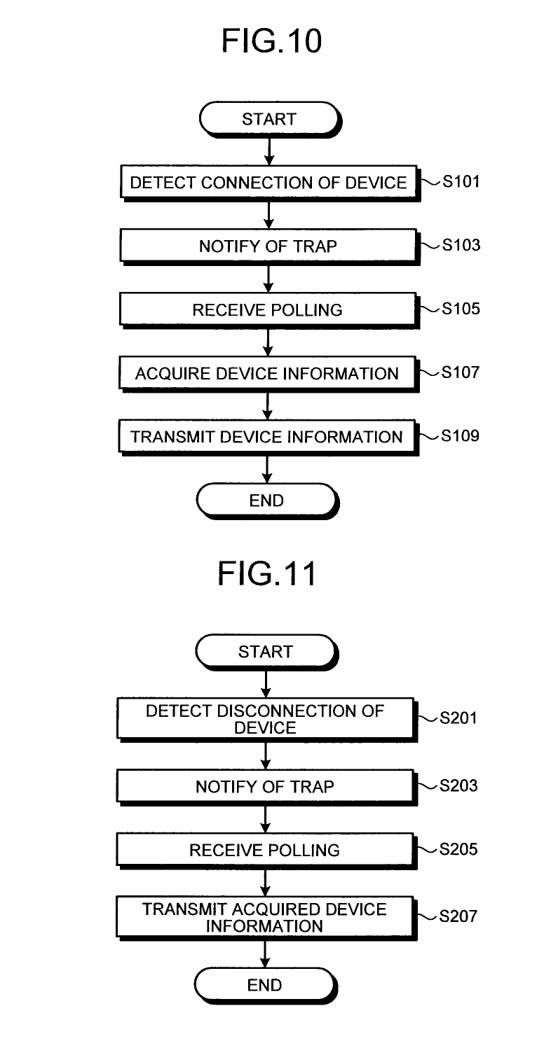

FIG. 10 is a flowchart illustrating exemplary processing performed when the PC 10 detects the connection of the device 20 in the device management system 1 according to the present embodiment.

The detection part 171 detects the connection with the local device through the communication interface 3 (step S101).

Then the transmission part 161 transmits the TRAP of the SNMP to the device management apparatus 30 (step S103). The TRAP from the SNMP includes the IP address of the PC10.

The reception part 162 receives polling (device information acquisition request) from the device management apparatus 30 based on the TRAP from the SNMP (step S105).

Next, the protocol conversion module is determined by the protocol determination module 172 of the first protocol conversion module 180 to n-th protocol conversion module 190. The protocol conversion module determined by the protocol determination module 172 converts the device information acquisition request to the device information acquisition request for the protocol of itself, communicates with the local device, and acquires the device information of the local device. The protocol conversion module converts the acquired device information of the local device to device information for the protocol for response to acquisition of the device information, acquires the IP address and MAC address of the PC 10 from the device information storage unit 141, and generates the response to acquisition of the device information including the IP address and MAC address of the PC 10, and the converted device information of the local device (step S107).

The transmission part 161 then transmits the response to acquisition of the device information which has been generated by the protocol conversion module to the device management apparatus 30 (step S109).

FIG. 11 is a flowchart illustrating exemplary processing performed when the PC 10 detects the disconnection of the device 20 in the device management system 1 according to the present embodiment.

First, the detection part 171 detects the disconnection of the local device through the communication interface 3 (step S201).

Then the transmission part 161 transmits the TRAP of the SNMP to the device management apparatus 30 (step S203). The TRAP from the SNMP includes the IP address of the PC10.

Next, the reception part 162 receives the polling (device information acquisition request) from the device management apparatus 30 based on the TRAP from the SNMP (step S205).

Next, the generation part 163 acquires the IP address and MAC address of the PC 10, and the device information of the local device from the device information storage unit 141 to generate the response to acquisition of the device information, and the transmission part 161 transmits the response to acquisition of the device information to the device management apparatus 30 (step S207).

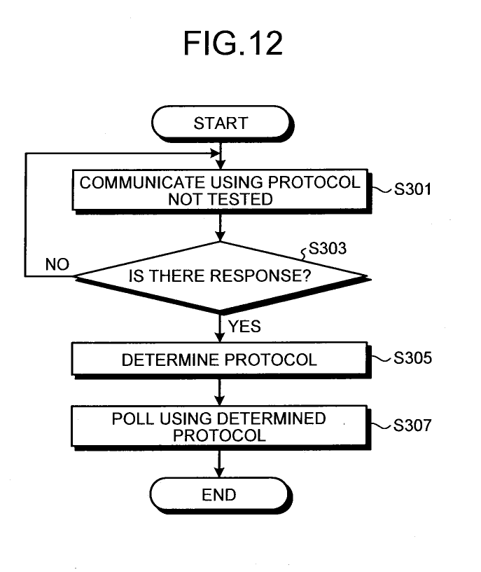

FIG. 12 is a flowchart illustrating exemplary protocol determination of the device management apparatus 30 according to the present embodiment.

First, when receiving the TRAP from the SNMP, the controller 350 of the device management apparatus 30 performs test communication using a protocol not tested yet (step S301) to confirm whether a response has been received (step S303).

When the response has not been received (step S303, No), the processing is returned to step S301.

On the other hand, when the response has been received (step S303, Yes), the protocol used for the test communication in which the response has been received is determined (step S305), and the protocol is used to transmit the polling (device information acquisition request) (step S307).

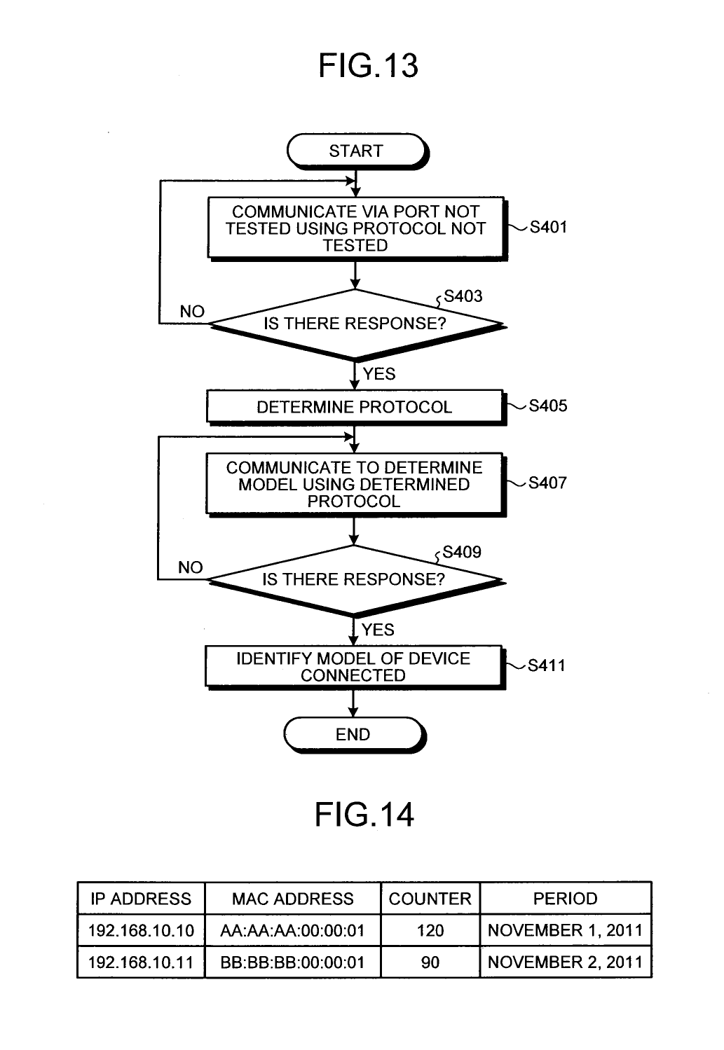

FIG. 13 is a flowchart illustrating exemplary determination of the protocol conversion module for the PCs 10 and 11 according to the present embodiment.

First, when the device information acquisition request is received by the reception part 162, the protocol determination module 172 makes test communication for a port not tested using a protocol conversion module not tested (step S401) to confirm whether a response has been received (step S403).

When the response has not been received (step S403, No), the processing is returned to step S401.

On the other hand, when the response has been received (step S403, Yes), the protocol conversion module used for the test communication in which the response has been received is determined (step S405), and the protocol conversion module is used to perform model determination communication (step S407).

When the response has not been received (step S409, No), the processing is returned to step S407.

On the other hand, when the response has been received (step S409, Yes), the model of the local device is determined as a model according to the model determination communication in which the response has been received (step S411).

As described above, according to the present embodiment, when the connection of the local device is detected, the device management apparatus 30 is notified of the TRAP and makes a device information acquisition request based on the notification. Therefore, even if the PC connected to the local device is switched to another one, the another PC newly connected to the local device is readily grasped by the device management apparatus 30.

Further, according to the present embodiment, when the disconnection of the local device is detected, the device management apparatus 30 is notified of the TRAP and makes a device information acquisition request based on the notification. Therefore, even if the PC connected to the local device is switched to another one, information of the local device managed by the PC is readily grasped by the device management apparatus 30.

### MODIFICATION

It is noted that the present invention is not limited to the above-mentioned embodiment, and various modifications are possible.

### First Modification

For example, in the above-mentioned embodiment, when the PC to which the local device is connected is switched to another one, the device management apparatus 30 updates the IP address and MAC address of the PC to continue the management of the local device. However, as illustrated in FIG. 14, device information of a local device may be managed for each PC having been connected.

### Second Modification

For example, in the above-mentioned embodiment, the local device such as the device 20 is the projector. However, the local device may be for example a printer.

FIG. 18 is a block diagram illustrating an exemplary configuration of a device 420 according to a modification. As illustrated in FIG. 18, the device 420 includes a communication unit 210, an operating unit 220, a display unit 230, a storage unit 240, a controller 250, and a printing unit 460.

The communication unit 210, the operating unit 220, the display unit 230, the storage unit 240, and the controller 250 are configured similarly to those of the above-mentioned embodiment.

When printing is requested from the PC 10 or 11 using PJL, the printing unit 460 performs printing.

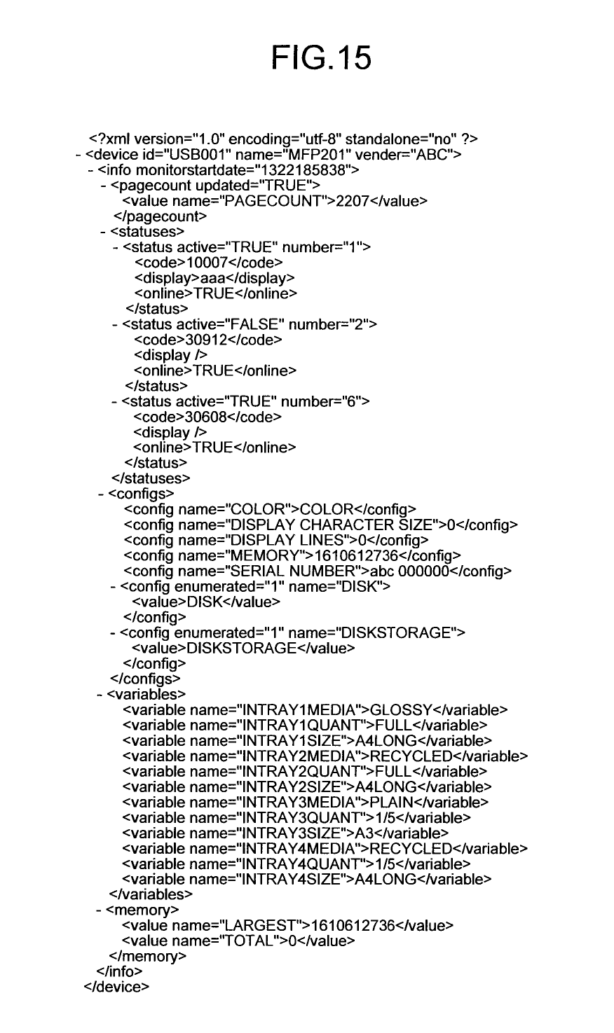

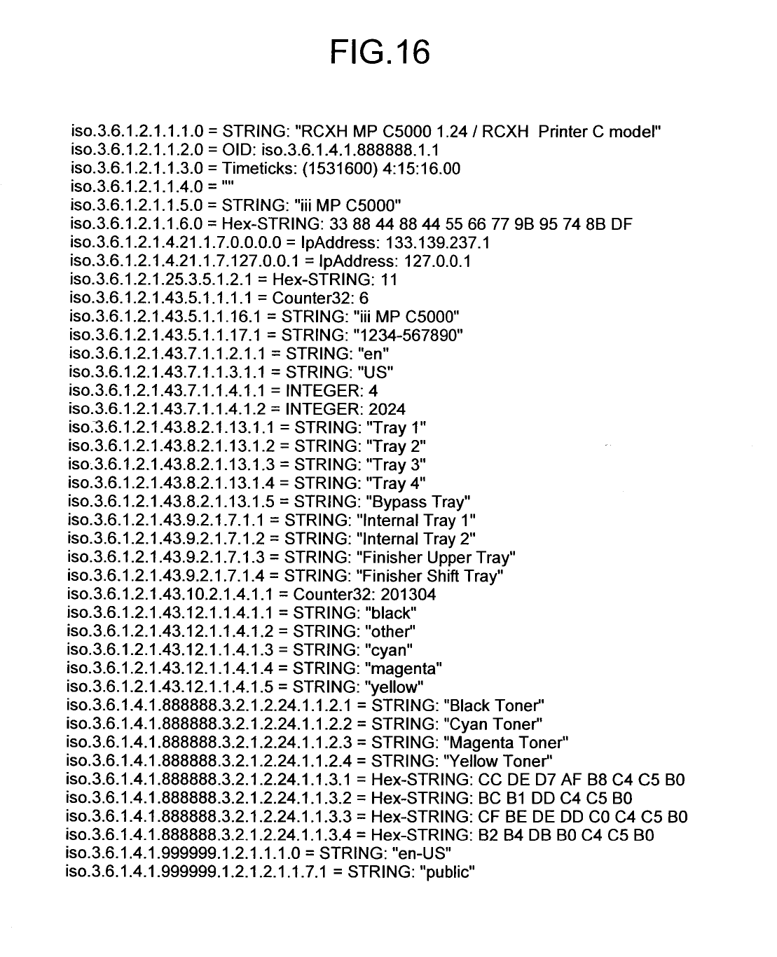

In such a configuration, the protocol conversion module formats the acquired device information of the local device in XML data as illustrated in FIG. 15, parses data of a “Variable” tab of the formatted XML data, and converts the parsed data for a protocol (XML) for response to acquisition of the device information. It is noted that the protocol conversion module may format the acquired device information of the local device in MIB data as illustrated in FIG. 16, and may convert the formatted MIB data for the protocol (SNMP) for response to acquisition of the device information.

(Hardware Configuration)

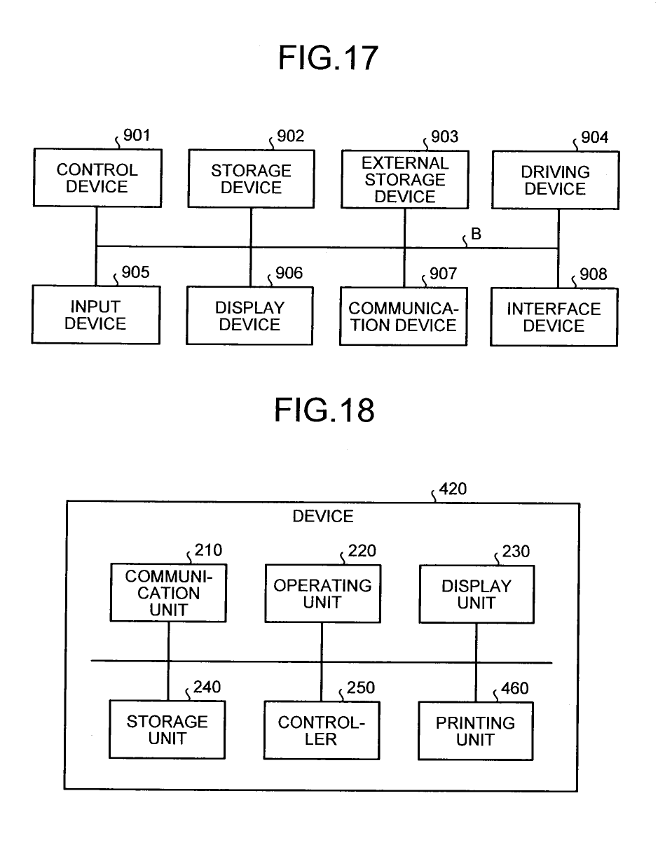

FIG. 17 is a block diagram illustrating an exemplary hardware configuration of PCs 10 and 11 and a device management apparatus 30 according to the present embodiment. As illustrated in FIG. 17, according to the present embodiment, the PCs 10 and 11 and the device management apparatus 30 include a control device 901 such as a CPU, a storage device 902 such as a ROM or RAM, an external storage device 903 such as an HDD or SSD, a driving device 904, an input device 905 such as a mouse or keyboard, a display device 906 such as a display, a communication device 907 such as an NIC, and an interface device 908. The devices are connected to one another by a bus B. The PCs and the device management apparatus can be configured with hardware using a normal computer.

The agent program executed on the PCs 10 and 11 according to the present embodiment and the device management program executed on the device management apparatus 30 according to the present embodiment are provided. The programs have an installable or executable file to be stored in a computer-readable storage medium such as a CD-ROM, a CD-R, a memory card, a digital versatile disk (DVD), or a flexible disk (FD).

The agent program executed on the PCs 10 and 11 according to the present embodiment and the device management program executed on the device management apparatus 30 according to the present embodiment may be provided by being stored on a computer connected to a network, such as the Internet, to be downloaded through the network. The agent program executed on the PCs 10 and 11 according to the present embodiment and the device management program executed on the device management apparatus 30 according to the present embodiment may be provided or distributed through the network such as the Internet. The agent program executed on the PCs 10 and 11 according to the present embodiment and the device management program executed on the device management apparatus 30 according to the present embodiment may be provided by being incorporated into the ROM or the like in advance.

The agent program executed on the PCs 10 and 11 according to the present embodiment and the device management program executed on the device management apparatus 30 according to the present embodiment have a module structure for implementation of each unit mentioned above on the computer. As actual hardware, the control device 901 executes a program having been read on the storage device 902 from the external storage device 903, whereby each unit is implemented on the computer.

According to the present invention, even if an information processing apparatus connected to a device is switched to another one, a device management apparatus is allowed to grasp the another information processing apparatus newly connected to the device in a simple manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus configured to communicate with a device through a first communication path and to communicate, through a second communication path, with a device management apparatus configured to manage the device, the information processing apparatus comprising:
a detection part configured to detect connection with the device through the first communication path;
a transmission part configured to transmit predetermined notification including identification information of the information processing apparatus to the device management apparatus when the connection with the device is detected;
a reception part configured to receive a device information acquisition request from the device management apparatus based on the predetermined notification; and
an acquisition part configured to acquire device information of the device based on the device information acquisition request,
wherein the transmission part transmits, to the device management apparatus, response to acquisition of the device information including the identification information of the information processing apparatus and the device information of the device.

2. The information processing apparatus according to claim 1, wherein the acquisition part acquires the device information of the device periodically,
the detection part detects disconnection of the device connected through the first communication path,
the transmission part transmits the predetermined notification to the device management apparatus when the disconnection of the device is detected,
the reception part receives the device information acquisition request from the device management apparatus based on the predetermined notification, and
the transmission part transmits, to the device management apparatus, the response to acquisition of the device information including identification information of the information processing apparatus and the device information of the device having been acquired by the acquisition part.

3. The information processing apparatus according to claim 1, wherein the acquisition part performs test communication with the device using various protocols, performs communication for acquisition of the device information using the protocol having been used for the test communication in which response has been received from the device, and acquires the device information of the device.

4. A device management system comprising:
a device management apparatus configured to manage a device; and
an information processing apparatus configured to communicate with the device through a first communication path and to communicate with the device management apparatus through a second communication path,
the information processing apparatus comprising:
a detection part configured to detect connection with the device through the first communication path;
a transmission part configured to transmit predetermined notification including identification information of the information processing apparatus to the device management apparatus when the connection with the device is detected;
a reception part configured to receive a device information acquisition request from the device management apparatus based on the predetermined notification; and
an acquisition part configured to acquire device information of the device based on the device information acquisition request,
wherein the transmission part transmits, to the device management apparatus, response to acquisition of the device information including identification information of the information processing apparatus and the device information of the device, and
the device management apparatus comprises a controller configured to transmit the device information acquisition request to the information processing apparatus based on the predetermined notification and to associate and manage the identification information of the information processing apparatus and the device information of the device included in the response to acquisition of the device information.

5. A device management method performed by an information processing apparatus configured to communicate with a device through a first communication path and to communicate, through a second communication path, with a device management apparatus configured to manage the device, the method comprising the steps of:
detecting connection with the device through the first communication path;
transmitting predetermined notification including identification information of the information processing apparatus to the device management apparatus when the connection with the device is detected;
receiving a device information acquisition request from the device management apparatus based on the predetermined notification; and
acquiring device information of the device based on the device information acquisition request,
wherein in the transmitting step, response to acquisition of the device information including the identification information of the information processing apparatus and the device information of the device is transmitted to the device management apparatus.
